(19) United States
(12) Patent Application Publication
(10) Pub. No.: US 2004/0036056 A1
(43) Pub. Date: Feb. 26, 2004

(54) Non-formaldehyde reinforced thermoset plastic composites

(76) Inventors: Lawrence E. Shea, Reno, NV (US); Frank Ghiorso, Reno, NV (US)

Correspondence Address: William F. Hamrock, PA, 50 Winter Harbor Road, Kennebunkport, ME, 04046, US

(21) Appl. No.: 10/261,070

(22) Filed: Sep. 30, 2002

(30) Foreign Application Priority Data
Aug. 26, 2002 (TW) 091119310

(51) Int. Cl. C08G 14/02

(52) U.S. Cl. 252/182.13; 524/401; 528/86

(57) ABSTRACT

The invention relates to composition for crosslinking phenol-formaldehyde, phenol-resorcinol-formaldehyde, resorcinol-formaldehyde, tannin-formaldehyde, and similar thermosetting resins with a reactant nitroparaffin derivative, a pH adjuster, a viscosity controller, a polymerization shortstop, and water for use in Reinforced Thermal Plastic (RTP) Composite applications.

### BACKGROUND OF THE INVENTION

Efforts to replace the thermoset resin technology that incorporates an additional source of formaldehyde as a hardening agent have only produced very expensive alternative resin systems, often more cumbersome than what is currently being utilized. Efforts to replace formaldehyde hardening agents for use in Reinforced Thermoset Plastic (RTP), Composite applications have been very poor if not nonexistent.

It is the concern of the present applicants to provide a non-formaldehyde hardening agent, defined by the OSHA exposure level of less than 0.1 ppm, to be used with resinous thermosetting systems such as phenol-formaldehyde, resorcinol-formaldehyde, phenol-resorcinol-formaldehyde, tannin-formaldehyde, and similar resins formed in the reaction between an aldehyde, such as formaldehyde or formaldehyde donor, and a carbonyl containing monomer having a reactive hydrogen on a carbon or nitrogen atom adjacent to the carbonyl. It is also a concern of the present applicants that the non-formaldehyde hardening agent should be able to be customized to a variety of curing environments, at, below or above what is normally considered room temperature, with a flexible gel-time or working time. Since the hardening system is formaldehyde-free; it eliminates the safety hazards associated with the use of formaldehyde hardening agent systems in Reinforced Thermoset Plastic, herein after referred to as RTP Composite applications. In addition, since the resinous compositions can be cured at room temperature, heating in an oven is not needed though it could be used to reduce curing time. If radio frequencies are used to cure resinous compositions, the exposure time can also be reduced.

The two basic groups of plastic materials are thermoplastics and thermosets. Thermoplastic resins consist of long molecules, each of which may have side chains or groups that are not attached to other molecules (i.e., are not cross linked). They can be repeatedly melted and reformed so that any scrap generated in processing can be reused. No chemical change generally takes place during forming, provided the processing temperatures are not exceeded. The temperature service range of thermoplastics is limited by their loss of physical strength, and eventual melting at elevated temperatures.

Thermoset plastics, on the other hand, react during processing to form cross linked structures that cannot be remelted and reprocessed. Thermosets may be supplied in liquid form or as a partially polymerized solid molding powder. In their uncured condition, they can be formed to the finished product shape with or without pressure and polymerized by using chemicals or heat.

The distinction between thermoplastics and thermosets is not always clearly drawn. For example, thermoplastic polyethylene can be extruded as a coating for wire and subsequently cross linked, either chemically or by irradiation, to form a thermoset material that no longer will melt when heated. Some plastic materials even have members in both families; for instance, there are both thermoset and thermoplastic

polyester resins.

RTP Composites are reinforced plastics known by several names including Glass Reinforced Plastic (GRP), Fiberglass Reinforced Plastic (FRP), Composites and even simply Fiberglass. Specifically, RTP Composites contain a reinforcing fiber in a polymer matrix. Most commonly, the reinforcing fiber is fiberglass, although other reinforcements including high strength fibers such as aramid, graphite and carbon are used in advanced applications. The polymer matrix is a thermoset resin and articles of construction from such are considered as “non-metallic” RTP composites.

In the last three decades, many in the building industry, aerospace, the marine and transportation industries, colleges, wastewater treatment plants, semiconductor plants, and those in fire prevention and insurance businesses, have become aware that many of the non-metallic products, thermoplastic and thermoset, in common use posed serious fire problems. Almost all of the resin systems in use in the late 1960's or early 1970's and claimed as fire retardant weren't and most still aren't. This is explained more fully in applicant Shea's patent application filed in July 1974, which resulted in U.S. Pat. No. 4,053,447 issued in October 1977.

There were similar explanations of these problems in applicant Shea's U.S. Pat. No. 4,076,873 issued in February 1978 incorporated herein by reference. Much of the “complaint” against the plastics industries' manipulations of the term “fire retardant” is more fully set forth therein. Additionally, in applicant Shea's U.S. Pat. No. 4,107,127

issued in August 1978 incorporated herein by reference, more comment is made about the supposed fire retardance of many plastics materials.

It can be seen from the above applications and issued patents that there were serious problems in coming to terms with the expression “fire retardant” and that the applicant Shea's answer to the problem was to use phenol-resorcinol-formaldehyde (PRF) resins for RTP Composite application to provide what users claimed they wanted, that is true fire resistance and minimal smoke evolution, in structural products such as ductwork, electrical conduit, etc.

In U.S. Pat. No. 5,202,189, issued in April 1993 to applicant Shea incorporated herein by reference, continued to expand on the solution to the problems by setting forth specific ingredients in novolac formulations based on phenol-resorcinol-formaldehyde (PRF) resins, curable at ambient temperatures, and the phenol-resorcinol-formaldehyde (PRF) resins having specific molar ratios of phenols and aldehydes, as well as specific viscosities. This patent went into considerable detail on phenol-resorcinol-formaldehydes (PRF), their solids content, and alternative hardeners. Generally, these resinous compositions are two-part systems (a resol); the first being a resin such as phenol-formaldehyde, resorcinol-formaldehyde or phenol-resorcinol-formaldehydes (PRF) that are deficient in formaldehyde; and the second part is simply an aldehyde, such as formaldehyde or formaldehyde donor, called a hardener in the industry. The hardener is simply a method of introducing additional formaldehyde content to the mix (PRF) at the time of use. It is at this period that what had formerly been a deficiency of formaldehyde to hydroxyl molar ratio is “corrected” to provide the necessary additional formaldehyde to enable the mix to harden, and provide useful articles of commerce. These resinous systems can take advantage of the high reactivity of the resorcinol so as to make possible the room temperature cure of the RTP composition.

U.S. Pat. No. 5,202,189 provided a range of solids content in the resins from 61 to 62% solids, known in the industry as Mark V™ resins, and using a formaldehyde donor of either paraformaldehyde, or “Formcel”, a mixture of formaldehyde and methoxy methanol, etc., or water, as the hardener. Another formulation with higher solids content, from 64 to 82% solids, known in the industry as Mark VII™ resin, illustrates a degree of variation. We do not mean to be bound by these examples, since they can be varied somewhat.

Applicant Shea subsequently received U.S. Pat. No. 5,298,299, issued March 1994, and U.S. Pat. No. 5,383,994, issued January 1995, both patents are incorporated herein by reference. Both of these are set forth as examples and incorporated herein as though more fully set forth. These latter patents illustrate the role PRF thermoset resin can play in fire retardance. They can be used advantageously in creating hybrid precursors to provide industry benefits that might not otherwise be achieved.

As example, phenol, resorcinol, and phenol-resorcinol based resins are utilized in RTP for their superior ability to withstand fire and generate little smoke. A typical such thermoset resin is made from the condensation polymerization of phenol, resorcinol or phenol-resorcinol with an aldehyde, such as formaldehyde, or a formaldehyde donor, in the presence of a strong base. In order to produce a resin with a good shelf-life, the resin technology utilized to manufacture the resin is deficient of the aldehyde, such as formaldehyde. For the reaction of these resins to become complete, additional aldehyde, such as formaldehyde, is incorporated into the resin at the time of use. The completed reaction will transform the resin into a hardened material, which is suitable for production of reinforced thermoset plastic products. Resin systems such as phenol-formaldehyde, phenol-resorcinol-formaldehyde, resorcinol-formaldehyde, tannin-formaldehyde, and similar resins formed in the reaction between formaldehyde and a carbonyl containing monomer having a reactive hydrogen on a carbon or nitrogen atom adjacent to the carbonyl constitute a multi-billion dollar requirement for formaldehyde in the RTP Composite industry.

Sources of useful aldehydes, such as formaldehyde, trioxymethylene (C₃H₆O₃), hexamethylene tetramine, paraformaldehyde, etc., are well known in the industry. Additional formaldehyde-hardening agents for reinforced thermoset plastic applications are generally available in the form of liquid solution or a powdered formaldehyde donor, such as paraformaldehyde. Formaldehyde, formaldehyde solutions and paraformaldehyde usage can create some potentially serious safety and health issues. Both are considered possible carcinogens and the handling, transportation, storage and use of these potentially hazardous materials are closely watched by many regulatory agencies in the United States of America (EPA, OSHA, etc.) and other agencies in other countries. Various forms of liquid formaldehyde-hardening agents are available, such as formaldehyde in a water or

methanol solution. Liquid formaldehyde solutions are also considered a corrosive. Weaker concentrations contain less formaldehyde and are therefore less corrosive and less harmful. However, stronger concentrations are generally preferred because of their higher reactivity with the “target” resins. These stronger concentrations may evolve formaldehyde vapors (free-formaldehyde) under some circumstances. Weaker concentrations of liquid formaldehyde are less reactive, requiring the use of greater quantities, and substantial amounts of heat to produce the desired reaction, which in turn can release a substantial amount of formaldehyde vapor (free-formaldehyde) into the air. Paraformaldehyde is a powdered version of formaldehyde, and may also create a problem when used as the paraformaldehyde dust can be difficult to control, is potentially toxic and may even decompose and release formaldehyde vapor (free-formaldehyde). Thus, special attention to dilution ventilation is required when using these formaldehyde-hardening agents.

OSHA Fact Sheet No. OSHA 95-27 states “To protect workers exposed to formaldehyde, the Occupational Safety and Health Administration (OSHA) standard (29 CFR 1910.1048) applies to formaldehyde gas, its solutions, and a variety of material such as trioxane, paraformaldehyde, and resin formulations, and solids and mixtures containing formaldehyde that serve as sources of the substance. In addition to setting Permissible Exposure Levels (PEL), exposure monitoring and training, the standard requires medical surveillance and medical removal, record keeping, regulated areas, hazard communication, emergency procedures, primary reliance on engineering and work practices to control exposure, and maintenance and selection of personal protective

equipment.”

“The permissible exposure limit (PEL) for formaldehyde in all workplaces”, except agriculture, “covered by the OSH Act is 0.75 ppm measured as an 8-hour time weighted average (TWA). The standard includes a 2 ppm short-term exposure limit (STEL) (i.e., maximum exposure allowed during a 15-minute period).” Recently, the “action level” was reduced to “0.5 ppm measured over an eight (8) hour period”. “Training is required at least annually for all employees exposed to formaldehyde concentrations of 0.1 ppm or greater”. Thus, an exposure of less than 0.1 ppm is regarded as having no generation of “free-formaldehyde” and no action is required.

Limitations

It is very difficult to deal with free-formaldehyde in a normal shop environment, particularly when open mold processes are used to build useful articles of commerce. Over the past few decades, the governmental agencies within the USA have reduced the quantity of free-formaldehyde permitted in a shop environment from 5 ppm to less than 1 ppm.

If one is to maintain the possible benefits of the potential for superior fire retardance of PRF thermoset resins, it is desirable that a means must be devised to provide a substitute for the “hardener” or “catalyst” or the “cross-linking agent” that enables the pre-deficient mix of an aldehyde, such as formaldehyde or formaldehyde donor, containing resins to harden and make themselves a useful product for society.

The use of formaldehyde, formaldehyde solutions or paraformaldehyde as hardeners normally used to “correct” formaldehyde or formaldehyde donor deficiency, permitting thermosetting phenol based resin systems to work is well-known to one skilled in the art. It has been the concern of the applicants to provide an alternative hardening system that can be used with the “target” thermosetting resin systems deficient in molar ratios of formaldehyde and which require an additional aldehyde donation, or alternative donor, to harden. It has been another concern of the applicants to provide an alternative hardening system that provides a wide degree of gel-time. It is yet another concern of the applicants, to maintain or improve the fire-resistance and smoke evolution of products made from “target” thermosetting resin systems.

### BRIEF SUMMARY OF THE INVENTION

The present invention provides a non-formaldehyde hardening composition that can be used with some thermosetting resin systems that are deficient in formaldehyde. The non-formaldehyde hardener comprises, among others, four ingredients: 1) as a formaldehyde donor, a nitroparaffin cross linker with the formulas shown below; 2) a pH adjuster in a sufficient amount to retard or accelerate the reaction of the hardener with the resin; 3) a viscosity controller to thin or thicken the resinous composition; and 4) a polymerization shortstop capable of retarding the polymerization of the resin with the non-formaldehyde hardening agent. Some water is also required, although generally it is available in-situ in adequate amounts required for the hardener to cure the resinous

composition.

The pH adjuster may be either organic or inorganic and may be either acidic or base, depending upon the need. An inorganic pH adjuster is preferred, many of which are known. For alkaline (base) adjustments; Al(OH)₂, Ba(OH)₂, CaO, Ca(OH)₂, CsOH, KOH, LiOH, MgO, Mg(OH)₂, NaOH, and ZnSn(OH)₆. Other useful alkaline pH adjusters include alkyl amines and alkanolamines. For acidic adjustments; AlK(SO₄)₂, C₂H₄₀₂, C₇H₆O₂, HCl, HBr, HI, HNO₃, HClO₄, H₂SO₄, HF, HCO₂CH₃, and H₃PO₄ can be used. The pH adjuster is preferably mixed with the resin, but can also be mixed into the other components of the hardener.

A viscosity controller is used to adjust, make thinner or thicker, the viscosity (thickness) of the resinous composition to that which is desired for the application. Viscosity controllers can be derived from a number of sources including, and not limited to, Alcohol, Methanol, Nitroparaffin and derivatives, Silane, and Water. These viscosity controllers can be either acidic or base depending upon the needs. There are numerous corporations that manufacture suitable materials that can be used as viscosity controllers for this application. Examples of some of these commercial manufacturers include, and are not limited to, Buckman Laboratories, BYK-Chemie, Dow-Corning, OSi Specialties and Witco.

Several agents can be utilized as polymerization shortstops. An example of a polymer shortstop is a hydroxylamine, such as diethylhydroxylamine, or N-isopropylhydroxylamine. The polymer shortstop is preferably mixed with the resin, but it can be mixed with the non-formaldehyde hardening agent.

Examples of thermosetting resins that can be used with this non-formaldehyde hardening agent are phenol-formaldehyde, phenol-resorcinol-formaldehyde, resorcinol-formaldehyde, tannin-formaldehyde, and similar resins formed in the reaction between an aldehyde, such as formaldehyde (or formaldehyde donor), and a carbonyl containing monomer having a reactive hydrogen on a carbon or nitrogen atom adjacent to the carbonyl.

The use of the non-formaldehyde hardening agent with a “target” resin produces a cure time of between 5 minutes and up to several weeks in room temperature conditions, and in ambient temperatures from 34° F. to over 200° F. While not necessary, the use of additional heat can speed up the curing (polymerization) process. As such, the non-formaldehyde hardening agent can be tailored for a variety of temperatures, conditions (humidity), curing times and applications. As an example; one formulation demonstrated the ability to maintain a resin temperature of 100 degrees F. (38 degrees C.) for one week in a closed container and still have suitable viscosity for the manufacture of reinforced thermoset plastic composites.

The non-formaldehyde hardening agent useful herewith is based upon nitroparaffin derivatives, which are very stable and no free-formaldehyde can be detected in their use. Therefore, their handling, transportation, storage and use do not present any formaldehyde exposure problems. It is believed that the reaction of the nitroparaffin derivatives with the associated “target” resin is via chemical transfer, which means that the formaldehyde “required” will leave the source molecule when it is in direct contact with the target molecule. The transfer is very efficient and does not involve any formation of formaldehyde or formaldehyde vapor (free-formaldehyde). This non-formaldehyde hardening agent chemical transfer process completely eliminates the safety and health concerns associated with formaldehyde hardening agents. The resulting RTP composition has flexible gel-times, is formaldehyde-free, and produces products' that maintain or improve their fire-resistance and low smoke evolution characteristics.

### DETAILED DESCRIPTION OF THE PREFERRED EMBODIMENTS

Target Resins

The invention relates to formaldehyde containing thermosetting resins that can be used in the production or fabrication of RTP Composite articles. Such suitable target thermosetting resins include, and are not limited to, phenol-formaldehyde, phenol-resorcinol-formaldehyde, resorcinol-formaldehyde, tannin-formaldehyde, and similar resins formed in the reaction between an aldehyde, such as formaldehyde, and a carbonyl containing monomer having a reactive hydrogen on a carbon or nitrogen atom adjacent to the carbonyl.

As example, Phenolic thermosetting resins are formed by the condensation reaction of formaldehyde [HCHO] and phenol [C₆H₅OH], although almost any reactive

phenol such as cresols [CH₃C₆H₄OH] or aldehyde such as furfural [C₄H₃OCHO], trioxymethylene [C₃H₆O₃] and hexamethylene tetramine [C₆H₁₂N₄] can be used. Resorcinol thermosetting resins are condensation products of formaldehyde [HCHO], or other aldehyde, and resorcinol [C₆H₄(OH)₂] or a resorcinol derivative, such as tannin. Thermosetting resins containing a combination of these elements are commercially available. Phenol-formaldehyde, resorcinol-formaldehyde and phenol-resorcinol-formaldehyde resins are widely used in the manufacture of RTP Composite articles, especially those requiring resistance to heat and/or fire.

The “target” thermosetting resins are produced in the presence of a base, and the final pH of the “target” thermosetting resin is typically around 7 to 8. These “target” resins are typically liquid solutions and may be in a mixture of solvents. These “target” resins are manufactured deficient in formaldehyde in order to avoid premature gelling. Therefore, these “target” resins must use an additional component called a hardening agent to be useful in producing RTP Composite articles. It is not the intent of this invention to limit the hardening system to “target” thermosetting resin systems with a specific pH range of 7 to 8, as the hardening system can be adjusted for a wide variety of target thermoset resin system pH ranges.

One very important characteristic of any reinforced thermoset plastic resin system is its gel-time or working time. Depending upon the specific application, the manufacturing/fabrication process, the environmental conditions such as heat and humidity, and the gel-time of a typical reinforced thermoset plastic resin system is

formulated for a specific time range. If the gel-time is too short, the fabricators will not have enough time to manufacture a given product. If the gel-time is too long, the product throughput (production) is reduced. In addition, as fabrication locations vary, so do the operating environments. Some have high humidity and high temperatures, where others are quite the opposite.

The reactivity time of the target resin will depend upon the level of preliminary polymerization between the phenol, resorcinol, and formaldehyde donors. When related compounds such as phenol or resorcinol derivatives are used, the reactivity time will also be affected. In addition, the type and amount of polymerization shortstop used will affect the reactivity time of the target resin.

The reactivity time of the nitro paraffin derivative (non free-formaldehyde) hardening agent will depend upon the type and amount of the reactant or combination of reactants chosen, the type and amount of pH adjuster used, the type and amount of viscosity controller used, the type and amount of polymerization shortstop used, and the availability of water. Other additives may be included to improve certain properties of the nitro paraffin derivative (non free-formaldehyde) or of the reinforced plastic resin. These additives may in turn also affect the reactivity time of the resin.

Hardening Agent Composition

Presently, the industrial practice is to use formaldehyde, formaldehyde solutions, paraformaldehyde, or combinations thereof, as the reactive ingredient (formaldehyde donor) in the hardening agent for phenol-formaldehyde, resorcinol-formaldehyde, phenol-resorcinol-formaldehyde, tannin-formaldehyde, and similar resins formed in the reaction between an aldehyde, such as formaldehyde, and a carbonyl containing monomer having a reactive hydrogen on a carbon or nitrogen atom adjacent to the carbonyl, for reinforced thermoset plastics. The associated pot-life characteristics are somewhat fixed and inflexible. The disadvantages of using formaldehyde or paraformaldehyde hardening agents have been discussed above. The nitro paraffin derivative (non free-formaldehyde) hardening agents of this invention, among others, consist of the following ingredients:

I. As the reactive donor, a Nitroparaffin derivative, preferably a nitro alcohol, amino, alcohol or an oxazolidine, or a combination thereof.

It has been discovered that nitro and amino alcohols including 2-nitro-2-methyl-1-propanol, 2-nitro-2-ethyl-1,3-propanediol, and 2-nitro-2-hydroxy-methyl-1,3-propanediol are suitable formaldehyde donors without the evolution of free-formaldehyde during the production of RTP Composite articles. A particularly preferred nitro/amino alcohol is 2-nitro-2-hydroxy-methyl-1,3-propanediol (TRIS-NITRO® ANGUS Chemical Company).

The oxazolidine can be either monocyclic or bicyclic. It has been discovered that oxazolidines including 3,3′-methylenebis(5-methyloxazolidine), 3,3′-methylenebis(tetrahydro-2H-1,3-oxazine), 1-aza-5-ethyl-3,7-dixabicyclo-(3,3,0)octane, 4,4-Dimethyl-1-oxa-3-azacyclopentane and 5-hydroxymethl-1-aza-3,7-dioxzbiocyclo

[3,3,0] octane are suitable donors without the evolution of free-formaldehyde during the production of Reinforced Thermoset Plastic (RTP) Composite articles. Other oxazolidines are known in the art but they are generally less satisfactory then the oxazolidines of the present invention. A particularly preferred oxazolidine is 5-hydroxymethl-1-aza-3,7-dioxzbiocyclo [3,3,0] octane (Zoldine® ZT-100, Zoldine® ZT-65, Zoldine® ZT-55, and Zoldine® ZT-40, ANGUS Chemical Company).

It has been discovered that the nitro paraffin derivative (non free-formaldehyde) hardening agent can be comprised of one element or a combination of elements, so a mixture of two or more reactant derivatives can be used simultaneously, for example, to achieve more flexibility in gel-time and at a variety of temperatures.

II. A pH adjuster, which can either retard or accelerate the reaction of the non-formaldehyde hardening agent with the target resin. As example, when using 2-nitro-2-hydroxy-methyl-1,3-propanediol, an acidic environment will increase the pot-life and a base environment will shorten the pot-life. However, when using 5-hydroxymethl-1-aza-3,7-dioxzbiocyclo [3,3,0] octane, just the opposite is true—an acidic environment will result in a short pot-life and a base environment will result in a long pot-life. Thus, when using a combination of reactive donors in conjunction with a suitable pH adjuster, flexibility of hardening characteristics can be designed into the target thermosetting resin system for a variety of applications and conditions. The pH adjuster can be mixed with the hardening agent or, preferably, with the target resin.

It has been discovered that some pH adjusters can also be utilized as a viscosity controller.

A. Base pH adjusters: Preferably an inorganic base, although an organic base, can be used. Examples of suitable inorganic bases are Al(OH)₂, Ba(OH)₂, CaO, Ca(OH)₂, CsOH, KOH, LiOH, MgO, Mg(OH)₂, NaOH, and ZnSn(OH)₆.

B. Acidic pH adjusters: Examples of suitable acids are AlK(SO₄)₂, C₂H₄O₂, C₇H₆O₂, HCl, HBr, HI, HNO₃, HClO₄, H₂SO₄, HF, HCO₂CH₃, and H₃PO₄.

III. A viscosity controller is used to adjust (make thicker or thinner) the viscosity of the resinous composition to that which is desired, if necessary. The viscosity controller should be a non-formaldehyde composition. It has been discovered that viscosity controllers can also be utilized as pH adjusters. Viscosity controllers can be derived from a number of sources including, but not limited to, Alcohol, Methanol, Nitroparaffin, Nitroparaffin derivatives, Silanes, and Water. There are numerous commercial manufacturers of suitable viscosity controllers for this application. Examples of some of these commercial manufacturers include, but are not limited to, Buckman Laboratories, BYK-Chemie, Dow-Corning, OSi Specialties and Witco.

IV. Several agents can be utilized as polymerization shortstops. A polymer shortstop can be a hydroxylamine, which can retard the reaction of the hardening agent with the resin. The particularly preferred hydroxylamines are diethylhydroxylamine, and N-isopropylhydroxylamine. The polymer shortstop is preferably mixed with the resin, but it can be mixed with the non-formaldehyde hardening agent. It has been discovered that a polymerization shortstop can be utilized as a pH adjuster and/or a viscosity controller.

V A sufficient amount of water. Without water available to the reactant, the rings of the reactant would not open and reaction of the nitroparaffin derivative(s) with the target resin would be nearly impossible. Water donation may be in the form of the water available within the target resin, or from the solution in which the other various components are provided, or even through the direct addition of water into the system.

Non-Formaldehyde Hardening Agent Formulations

The present industrial practice is to use aldehydes, such as formaldehyde, formaldehyde solution, paraformaldehyde, or a combination thereof, as the formaldehyde donor for the active ingredient in hardeners for the target resins. The disadvantages of using formaldehyde, formaldehyde solution, paraformaldehyde, or combination thereof, have been discussed above.

The reinforced thermoset plastic resin composition of the invention is principally a two-part system that is comprised of the target resin and the hardening agent. The composition of both parts may vary significantly, and the composition will be determined by the manufacturing/fabrication processes to be used, by the time and temperature to be used for curing, and the reactivity time of the target resin with that of the nitro paraffin

derivative (non free-formaldehyde) hardening agent. The improved hardener of this invention comprises, among others, the following four ingredients.

The nitroparaffin derivative. The amount of nitroparaffin derivative to be utilized as a thermoset resin hardener can be roughly calculated by the formaldehyde donation (hence, formaldehyde donor) required divided by the Stoichiometric percentage available from the nitroparaffin derivative to be used. In general, the nitro paraffin derivative (non free-formaldehyde) hardening agent will represent about 5 to 75% per resin weight of the target resin of the reinforced thermoset plastic resin composition. Excessive donation may result in the fracturing of the product during or after curing—too little will result in a non-cured or “falsecured” part.

The amount of nitro paraffin derivative (non free-formaldehyde) hardening agent to be used varies with differences in reactive concentrations of products utilized. Typically the reactive concentrations utilized vary from 40% to 100%. When mixed, the nitro paraffin derivative, non free-formaldehyde, hardening agent may contain 10 to 100 percent of the reactive nitroparaffin derivative. However, it is not the intent to exclude the use of lower reactive concentrations of within this embodiment.

A pH adjuster as previously discussed. Typically between 0 to 90 percent (by target resin weight) of the pH adjuster may be used to adjust the pot-life (or working life) as necessary.

III. A Viscosity Controller as previously discussed. Typically between 0 to 90 percent (by target resin weight) of the Viscosity Controller may be used to make the target resin thicker or thinner as necessary for the specific application.

IV. A Polymerization Shortstop as previously discussed. Typically, between 0 to 50 percent per target resin weight of the polymerization shortstop may be incorporated into the target resin to further retard the polymerization of the resin, as necessary.

Additional filler materials may also be incorporated into the reinforced thermoset plastic resin to improve certain other properties of the resin and the thermosetting composition. As these materials may also significantly contribute to the pH of the target resin, it is important to be able to adjust the pH accordingly. For those skilled in the art, it is known that gel-cup tests are an important procedure typically utilized to determine the curing characteristics, providing results from which the necessary adjustments can be made.

In one method, all of the ingredients are pre-mixed into the reactive nitro paraffin derivative (non free-formaldehyde) hardening agent, which in turn is mixed into the target resin. In another method, the non-formaldehyde hardening agent consisted of only a nitroparaffin derivative and the balance of the ingredients were premixed into the target resin, which in turn were mixed together. In another method, a combination of reactive nitro paraffin derivatives were used—with one of the nitro paraffin derivatives being utilized as an accelerator for the other nitro paraffin derivative. In yet another method, a

combination of reactive nitro paraffin derivatives were used, with one of the nitro paraffin derivatives being utilized as an retarder for the other nitro paraffin derivative. These compositions were extremely stable and provided fully cured parts.

The reactivity of the hardener composition will be affected by the type and amount of the nitroparaffin derivative(s) used. Blending of nitroparaffin derivatives with each other showed no signs of separation during the manufacture of reinforced thermoset plastic articles. This included the specific blending of oxazolidines with amino/nitro alcohols, which also showed no signs of separation during the manufacture of reinforced thermoset plastic articles.

This flexibility has afforded the production of parts in a variety of temperatures, including in temperatures around 34 degrees F. (1 degree C.), at room temperature and at elevated temperatures (greater than 180 degrees F. or 82 degrees C.) via the use of external heat sources such as ovens or radiant heaters. In all cases, the production of free-formaldehyde (or formaldehyde vapor) during the manufacture of reinforced thermoset plastic articles was negated, including with the utilization of closed ovens at high temperatures for accelerated heat curing of parts.

There are numerous manufacturing processes utilized for the fabrication of FRP/GRP parts. These can generally be classified into either a) Open Contact Molding or b) Closed Contact Molding. These processes include and are not limited to:

1. Open Contact Molding

Hand lay-up

Chopper (Atomized Resin Applicator)

Flow-Chop, Flow-Coat, etc. (Non-Atomized Resin Applicator)

Filament-Winding

Resin Roller

Other

2. Closed Contact Molding

Low pressure Compression Molding

Resin Transfer Molding (RTM)

Vacuum Assisted Resin Transfer Molding (VA-RTM)

Pultrusion

Vacuum Bagging

Infusion Molding

Other

It is known to one skilled in the art, that Open Contact Molding is the greatest producer of airborne emissions in the manufacture of FRP/GRP products. Specifically, the Hand Lay-up, Chopping and Filament Winding processes are the most commonly utilized. Major efforts are being undertaken to reduce the airborne emissions of styrene based resins systems for these applications. Filament Winding processes are one of the greatest potential sources of emissions due to the surface to air contact ratios. It has been found that the reduction of free-styrene emissions for filament winding applications has a strong correlation for the other FRP manufacturing applications. It has also been found that the replacement of Chopper Gun processes (atomized resin applicators) with Flow-Chop processes (non-atomized resin applicators) greatly reduces the airborne emissions of free-styrene. The reduction of free-formaldehyde emissions for these same processes will have a direct correlation to the free-styrene counterparts. As such, the reduction of free-formaldehyde emissions for filament winding applications validates the ability to reduce free-formaldehyde emissions for other FRP manufacturing applications.

The testing used to validate the aforementioned results included, but was not limited to, the following examples.

### EXAMPLE 1

A resorcinol-formaldehyde novolac resin, representing the present state of the art, was tested for gel-time and free-formaldehyde generation. A formaldehyde solution

consisting of about 55% liquid formaldehyde, about 35% methanol and 10% water was used as the formaldehyde donor (hardener). This mixture is sold commercially and is commonly known as “Formcel”. Approximately 5½ pounds of the phenol-resorcinol-formaldehyde novolac resin and appropriate amount of hardener necessary was added to provide an additional formaldehyde donation of approximately 7% needed to produce a fully cured part. A donation range of from approximately 6% to 12% was determined a suitable to effect a full cure. This combination was mixed at room temperature for approximately 2 minutes. The viscosity did not need to be adjusted. However, it is known to one skilled in the art that methanol, for example, can be used as a viscosity controller.

Various manufacturing processes can be utilized for the manufacture of thermosetting parts. This resin was then used to fabricate a cylindrical object using filament winding equipment, representing one of the typical manufacturing processes and environments. During the manufacturing process, the free-formaldehyde was measured using both a “Formaldehyde Meter” and “formaldehyde” sensing badges. The room temperature gel-time was approximately 60 minutes. The part was left to fully cure at room temperature. The “free-formaldehyde” generated was recorded to be over 5 ppm.

The fire performance of this formulation and method is well known. Products made as in this example have been subjected to numerous small and large-scale “fire tests” and demonstrated superior fire performance characteristics. This sample was subjected to a “fire test” using an electric radiant coil set to provide a Heat Flux Input

(into the sample) setting of 50-kW/m² for a 15 minute duration. The sample demonstrated no flaming and had an extremely low evolution of smoke.

### EXAMPLE 2

A hardener was prepared by combining paraformaldehyde with a nitro alcohol (nitro paraffin derivative) formaldehyde scavenger to provide a formaldehyde donation of approximately 7%. EXAMPLE 1 was repeated using this new hardener. The room temperature gel-time was approximately 90 minutes. The part was left to fully cure at room temperature. The “freeformaldehyde” generated was approximately 3 ppm.

This sample was subjected to a “fire test” using an electric radiant coil set to provide a Heat Flux Input (into the sample) setting of 50-kW/m² for a 15 minute duration. The sample demonstrated no flaming and had an extremely low evolution of smoke.

### EXAMPLE 3

EXAMPLE 2 was repeated using an elevated temperature curing system. The gel-time was approximately 45-minutes. The “free-formaidehyde” generated was approximately 3 ppm.

This sample was subjected to a “fire test” using an electric radiant coil set to provide a Heat Flux Input (into the sample) setting of 50-kW/m² for a 15 minute duration. The sample demonstrated no flaming and had an extremely low evolution of smoke.

### EXAMPLE 4

A hardener was prepared using a nitroparaffin derivative (oxazoldine) to provide a formaldehyde donation of approximately 7%. EXAMPLE 1 was repeated using this new hardener. The room temperature gel-time was 20 minutes. The part was left to fully cure at room temperature. The “free-formaldehyde” generated was less than 0.1 ppm.

This sample was subjected to a “fire test” using an electric radiant coil set to provide a Heat Flux Input (into the sample) setting of 50-kW/m² for a 15 minute duration. The sample demonstrated no flaming and had an extremely low evolution of smoke.

### EXAMPLE 5

EXAMPLE 4 was repeated with the 5% addition of a pH adjuster to retard the polymerization. The room temperature gel-time was 60 minutes. The part was left to fully cure at room temperature. The “free-formaldehyde” generated was less than 0.1 ppm.

This sample was subjected to a “fire test” using an electric radiant coil set to provide a Heat Flux input (into the sample) setting of 50-kW/m² for a 15 minute duration. The sample demonstrated no flaming and had an extremely low evolution of smoke.

### EXAMPLE 6

EXAMPLE 4 was repeated with the 5% addition of a viscosity controller/polymerization shortstop to retard the polymerization. The room temperature gel-time was 60 minutes. The part was left to fully cure at room temperature. The “free-formaldehyde” generated was less than 0.1 ppm.

This sample was subjected to a “fire test” using an electric radiant coil set to provide a Heat Flux Input (into the sample) setting of 50-kW/m² for a 15 minute duration. The sample demonstrated no flaming and had an extremely low evolution of smoke.

### EXAMPLE 7

EXAMPLE 4 was repeated with the 7% addition of a polymerization shortstop to retard the polymerization. The room temperature gel-time was 60 minutes. The part was left to fully cure at room temperature. The “free-formaldehyde” generated was less than 0.1 ppm.

This sample was subjected to a “fire test” using an electric radiant coil set to provide a Heat Flux Input (into the sample) setting of 50-kW/m² for a 15 minute duration. The sample demonstrated no flaming and had an extremely low evolution of smoke.

### EXAMPLE 8

EXAMPLE 4 was repeated with the 9.5% addition of a viscosity controller that can also serve as a pH adjuster to accelerate the polymerization. The room temperature gel-time was 15 minutes. The part was left to fully cure at room temperature. The “free-formaldehyde” generated was less than 0.1 ppm.

This sample was subjected to a “fire test” using an electric radiant coil set to provide a Heat Flux Input (into the sample) setting of 50-kW/m² for a 15 minute duration. The sample demonstrated no flaming and had an extremely low evolution of smoke.

### EXAMPLE 9

A hardener was prepared using a nitroparaffin derivative (nitro/amino alcohol) to provide a formaldehyde donation of approximately 7%. EXAMPLE 1 was repeated using this new harder. The room temperature gel-time was in excess of 96 hours. The part was left to fully cure at room temperature. The “free-formaldehyde” generated was less than 0.1 ppm.

This sample was subjected to a “fire test” using an electric radiant coil set to provide a Heat Flux Input (into the sample) setting of 50-kW/m² for a 15 minute duration. The sample demonstrated no flaming and had an extremely low evolution of smoke.

### EXAMPLE 10

EXAMPLE 9 was repeated with the addition of a 20% pH adjuster to retard the polymerization. The room temperature gel-time was in excess of 120 hours. The part was left to fully cure at room temperature. The “free-formaldehyde” generated was less than 0.1 ppm.

This sample was subjected to a “fire test” using an electric radiant coil set to provide a Heat Flux Input (into the sample) setting of 50-kW/m² for a 15 minute duration.

The sample demonstrated no flaming and had an extremely low evolution of smoke.

### EXAMPLE 11

EXAMPLE 9 was repeated with the addition of a 7.5% pH adjuster to accelerate the polymerization. The room temperature gel-time was approximately 8 hours. The part was left to fully cure at room temperature. The “free-formaldehyde” generated was less than 0.1 ppm.

This sample was subjected to a “fire test” using an electric radiant coil set to provide a Heat Flux Input (into the sample) setting of 50-kW/m² for a 15 minute duration. The sample demonstrated no flaming and had an extremely low evolution of smoke.

### EXAMPLE 12

EXAMPLE 9 was repeated with the 5% addition of a polymerization shortstop to retard the polymerization. The room temperature gel-time was in excess of 96 hours. The part was left to fully cure at room temperature. The “free-formaldehyde” generated was less than 0.1 ppm.

This sample was subjected to a “fire test”, using an electric radiant coil set to provide a Heat Flux Input (into the sample) setting of 50-kW/m² for a 15 minute duration. The sample demonstrated no flaming and had an extremely low evolution of smoke.

### EXAMPLE 13

EXAMPLE 9 was repeated with the 10% addition of a viscosity controller that can also serve as a pH adjuster to accelerate the polymerization. The room temperature gel-time was approximately 4 hours. The part was left to fully cure at room temperature. The “freeformaldehyde” generated was less than 0.1 ppm.

This sample was subjected to a “fire test” using an electric radiant coil set to provide a Heat Flux Input (into the sample) setting of 50-kW/m² for a 15 minute duration. The sample demonstrated no flaming and had an extremely low evolution of smoke.

### EXAMPLE 14

A hardener was prepared using a combination of nitroparaffin derivatives (oxazoldine and nitro/amino alcohols) to provide a formaldehyde donation of approximately 7%. EXAMPLE 1 was repeated using this new harder. The room temperature gel-time was 45 minutes. The part was left to fully cure at room temperature. The “free-formaldehyde” generated was less than 0.1 ppm.

This sample was subjected to a “fire test” using an electric radiant coil set to provide a Heat Flux Input (into the sample) setting of 50-kW/m² for a 15 minute duration. The sample demonstrated no flaming and had an extremely low evolution of smoke.

### EXAMPLE 15

EXAMPLE 14 was repeated an elevated temperature curing system of approximately 145 degrees F. (63 degrees C.). The gel-time was approximately 15-minutes and a full cured was achieved in 1-hour. The “free-formaldehyde” generated was approximately 0.1 ppm.

This sample was subjected to a “fire test” using an electric radiant coil set to provide a Heat Flux Input (into the sample) setting of 50-kW/m² for a 15 minute duration. The sample demonstrated no flaming and had an extremely low evolution of smoke.

### EXAMPLE 16

EXAMPLE 14 was repeated with the 35% addition of a pH adjuster to retard the polymerization. The room temperature gel-time was 90 minutes. The part was left to fully cure at room temperature. The “free-formaldehyde” generated was less than 0.1 ppm.

This sample was subjected to a “fire test” using an electric radiant coil set to provide a Heat Flux Input (into the sample) setting of 50-kW/m² for a 15 minute duration. The sample demonstrated no flaming and had an extremely low evolution of smoke.

### EXAMPLE 17

EXAMPLE 14 was repeated with the 10% addition of a polymerization shortstop to retard the polymerization. The room temperature gel-time was 90 minutes. The part was left to fully cure at room temperature. The “free-formaldehyde” generated was less

than 0.1 ppm.

This sample was subjected to a “fire test” using an electric radiant coil set to provide a Heat Flux Input (into the sample) setting of 50-kW/m² for a 15 minute duration. The sample demonstrated no flaming and had an extremely low evolution of smoke.

### EXAMPLE 18

A hardener was prepared using a combination of nitroparaffin derivatives ((oxazoldine and nitro/amino alcohols) to provide a formaldehyde donation of approximately 7%. EXAMPLE 1 was repeated using this new harder at a temperature lower then room temperature (34 degrees F.). The reduced temperature gel-time was 12 hours. The part was left to fully cure at reduced temperature in 24 hours. The “free-formaldehyde” generated was less than 0.1 ppm.

This sample was subjected to a “fire test” using an electric radiant coil set to provide a Heat Flux Input (into the sample) setting of 50-kW/m² for a 15 minute duration. The sample demonstrated no flaming and had an extremely low evolution of smoke.

What is claimed is:

1. A composition for crosslinking and hardening thermosetting resins formed in the reaction between an aldehyde and a carbonyl containing monomer having a reactive hydrogen on a carbon or nitrogen atom adjacent to the carbonyl; comprising;
a) a reactant nitroparaffin derivative or combination thereof,
1) b) a pH adjuster in the amount sufficient to either retard or accelerate the reaction of the thermosetting resin with the nitroparaffin derivative of (a),
2) c) a viscosity controller capable of adjusting the viscosity of the resinous thermoset material,
3) d) a polymerization shortstop capable of retarding the reaction of the resinous thermosetting material with the nitroparaffin derivative of (a),
4) e) an effective amount of water.

2. The composition as in claim 1 wherein the thermosetting resins comprise phenol-formaldehyde, phenol-resorcinol-formaldehyde, resorcinol-formaldehyde, tannin-formaldehyde, and similar thermosetting resins.

3. The composition as in claim 2 wherein the aldehyde comprises a formaldehyde or formaldehyde donor.

4. The composition as in claim 1 wherein said pH adjuster is a base comprising 2Al(OH)₃, Ba(OH)₂, Ca(OH)₂, CsOH, KOH, LiOH, MgO, Mg(OH)₃, NaOH, and ZnSn(OH)₆.

5. The composition as in claim 1 wherein said pH adjuster is an acid comprising AlK(SO₄)₂, C₂H₄O₂, C₇H₆₀₂, HCl, HBr, HI, HNO₃, HClO₄, H₂SO₄, HF, HCO₂CH₃, and H₃PO₄.

6. The composition as in claim 1 wherein said viscosity controller is derived from a number of sources comprising Alcohol, Methanol, Nitroparaffin, Nitroparaffin derivatives, Silane, and Water.

7. The composition as in claim 1 wherein the said polymerization shortstop comprises a hydroxylamine.

8. The composition as in claim 1 where the reactant comprises 5 to 75% wt % nitroparaffin derivative, 0 to 80% wt % ph adjuster, 0 to 90 wt % viscosity controller, and 0 to 50 wt % hydroxylamine.

9. The composition as in claim 1 wherein said reactant nitroparaffin derivative is 2-nitro-2-hydroxy-methyl-1,3-propanediol.

10. The composition as in claim 1 wherein said reactant nitroparaffin derivative is 2-Nitro-2-methyl-1-propanol.

11. The composition as in claim 1 wherein said reactant nitroparaffin derivative is 2-nitro-2-ethyl-1,3-propanediol.

12. The composition as in claim 1 wherein said reactant nitroparaffin derivative is 2-nitro-1-butanol.

13. The composition as in claim 1 wherein said reactant nitroparaffin derivative is 5-hydroxymethyl-1-aza-3,7-dioxabicyclo [3,3,0] octane.

14. The composition as in claim 1 wherein said reactant nitroparaffin derivative is 4,4-dimethyl-1-oxa-3-azacyclopentane.

15. The composition as in claim 1 wherein said reactant nitroparaffin derivative is 5-ethyl-1-aza-3,7-dioxabicyclo [3,3,0] octane.

16. The composition as in claim 1 wherein said reactant nitroparaffin derivative is 7A-ethyldihydro-1H,3H-oxazolo [3,4-C] oxazole.

17. The composition as in claim 1 wherein said reactant nitroparaffin derivative is 3,3′-methylenebis(5-methyloxazolidine).

18. The composition as in claim 1 wherein said reactant nitroparaffin derivative is 3,3′-methylenebis(tetrahydro-2H-1,3-oxazine).

19. The composition as in claim 1 wherein said reactant nitroparaffin derivative is 1-aza-5-ethyl-3,7-dioxabicyclo-(3,3,0) octane.

20. The composition as in claim 1 wherein additional filler materials may be incorporated to improve certain other properties of the resin and the resulting reinforced thermosetting plastic composition,

21. A hardenable thermoset composition comprising:
a) phenol-formaldehyde, phenol-resorcinol-formaldehyde, resorcinol-formaldehyde, tannin-formaldehyde, or similar resins formed in the reaction between an aldehyde, such as formaldehyde (or formaldehyde donor), and a carbonyl containing monomer having a reactive hydrogen on a carbon or nitrogen atom adjacent to the carbonyl,
b) a reactant nitroparaffin derivative compound,
c) a pH adjuster in the amount sufficient to retard or accelerate the reaction of the nitroparaffin derivative compound with the resinous composition of (a),
d) a viscosity controller compatible with the pH adjuster of ©) and capable thickening or thinning the resinous composition of (a),
e) a polymerization shortstop compatible with the pH adjuster (b) and the viscosity controller ©) and is capable of retarding the reaction of nitroparaffin derivative compound of (b) with the composition of (a), f) an effective amount of water.

22. The composition as in claim 21 wherein the thermosetting resin is at least one member of the group consisting of phenol, resorcinol, phenol-resorcinol, phenol-formaldehyde, phenol-nitroparaffin derivative, resorcinol-formaldehyde, resorcinol-nitroparaffin derivative, phenol-resorcinol-formaldehyde, phenol-resorcinol-nitroparaffin derivative, and similar thermosetting resins formed in the reaction between an aldehyde, such as formaldehyde (or formaldehyde donor), and a carbonyl containing monomer having a reactive hydrogen on a carbon or nitrogen atom adjacent to the carbonyl

23. The composition as in claim 21 which is cured at room temperature.

24. The composition as in claim 21 which is cured at below room temperature.

25. The composition as in claim 21 which is cured at above room temperature.

26. The composition as in claim 21 which is cured or with radio-frequency, light wave or oven heating.

27. A composition comprising,
(a) Reinforcement materials,
(b) A cured composition of claim 21

28. The composition of claim 21 wherein the reinforcement material is at least one member of the group consisting of glass fibers, carbon fibers, graphite fibers, synthetic fibers, woven roving, fiberglass mat, filament winding glass, organic veil materials, inorganic veil materials, and nanotubes.

29. A method of forming a composition by cross linking and hardening thermosetting resins formed in the reaction between an aldehyde and a carbonyl containing monomer having a reactive hydrogen comprising reacting the thermosetting resins with a reactant comprising 5 to 75 wt % nitroparaffin derivative,
0 to 80 wt pH adjuster,
0 to 90 wt % viscosity controller,
0 to 50 wt % hydroxylamine
and an effective amount of water,

30. The method of claim 29 wherein the thermosetting resins comprise phenol-formaldehyde, phenol-resorcinol-aldehyde, resorcinol-formaldehyde, tannin-formaldehyde, and similar thermosetting resins.

31. A method of bonding Reinforced Thermoset Plastic (RTP) Composite articles together with the composition as in claim 21

32. The composition as in claim 27 that is made using an Open Contact Molding process

33. The composition as in claim 27 that is made using a combination of Open Contact Molding processes

34. The composition as in claim 27 that is made using Hand Layup methods

35. The composition as in claim 27 that is made using Flow-Chop methods

36. The composition as in claim 27 that is made using Flow-Coating methods

37. The composition as in claim 27 that is made using Filament Winding methods

38. The composition as in claim 27 that is made using Tape Winding/Placement methods

39. The composition as in claim 27 that is made using Carbon Tow Placement Fiber methods

40. The composition as in claim 27 that is made using a Closed Contact Molding process

41. The composition as in claim 27 that is made using a combination of Closed Contact Molding processes

42. The composition as in claim 27 that is made using Compression Molding processes

43. The composition as in claim 27 that is made using Resin Transfer Molding processes

44. The composition as in claim 27 that is made using Vacuum Assisted Resin Transfer Molding Processes

45. The composition as in claim 27 that is made using Pultrusion processes

46. The composition as in claim 27 that is made using Vacuum Bagging processes

47. The composition as in claim 27 that is made using Infusion molding processes

48. The composition as in claim 27 that is made using a combination of Open and Closed Molding processes
